(19) United States
(12) Patent Application Publication
(10) Pub. No.: US 2018/0111153 A1
(43) Pub. Date: Apr. 26, 2018

(54) METHOD OF MANUFACTURING COMPOSITE FILM

(71) Applicant: TEIJIN LIMITED, Osaka-shi, Osaka (JP)

(72) Inventor: Noboru TANIKAWA, Osaka-shi (JP)

(73) Assignee: TEIJIN LIMITED, Osaka-shi, Osaka (JP)

(21) Appl. No.: 15/560,806

(22) PCT Filed: Dec. 10, 2015
(86) PCT No.: PCT/JP2015/084721

§ 371 Date: Sep. 22, 2017

(30) Foreign Application Priority Data
Mar. 27, 2015 (JP) 2015-067606

(51) Int. Cl. B05C 13/00; B01D 69/12; B01D 67/00; B01D 71/26; B05D 1/26; B05D 3/10; B05D 3/00; B05C 3/12; B05C 9/12

(52) U.S. Cl. CPC B05C 13/00; B01D 69/12; B01D 67/0088; B01D 67/0095; B05C 9/12; B05D 1/265; B05D 3/107; B05D 3/007; B05C 3/125; B01D 71/26

(57) ABSTRACT

A method of manufacturing a composite film, the method including: a coating step including coating a coating liquid containing a resin on one surface or both surfaces of a porous substrate to form a coating layer, the porous substrate having a tensile strength at 2% elongation in a machine direction of 0.3 N/cm or more; a solidification step including solidifying the resin by bringing the coating layer into contact with a solidifying liquid to obtain a composite film including the porous substrate and a porous layer that is formed on one surface or both surfaces of the porous substrate and that includes the resin; and a water wishing step including washing the composite film with water by transporting the composite film at a transport speed of 30 m/min or more in a water washing tank; the water washing tank including two or more drive rolls for supporting and transporting the composite film, and a path length between any two adjacent drive rolls being from 0.5 m to 5 m.

### TECHNICAL FIELD

The present disclosure relates to a method of manufacturing a composite film.

### BACKGROUND ART

Composite films including a porous substrate and a porous layer provided on the porous substrate are conventionally known as battery separators, gas filters, liquid filters, and the like. As a method of manufacturing the composite film described above, a method, that is called as a wet process, is known in which a coating liquid containing a resin is coated on a porous substrate to form a coating layer; solidifying the resin contained in the coating layer by immersing the resultant to a solidifying liquid; and forming a porous layer via water washing and drying (see Patent Document 1, for example). The wet process has been known as a method which enables to favorably porosify a porous layer containing a resin.

### RELATED ART DOCUMENT

Patent Document
Patent Document 1: JP 5134526 B

### SUMMARY OF INVENTION

### Technical Problem

In order to mass-produce a composite film including a porous substrate and a porous layer provided on the porous substrate by the wet process manufacturing method, it is preferable to transport a porous substrate having a long length to be subjected to respective steps of coating, solidification, water-washing, and drying in sequence, and to carry out these steps continuously. At this time, the porous substrate is preferably transported at an increased transport speed in the respective steps, in terms of improving productivity. However, when the water washing step is carried out while transporting the porous substrate at an increased transport speed, there may be a case in which the composite film may be elongated or wrinkles may occur in the film, during the transport of the composite film through water. So far, there has not yet been proposed a suitable means to solve the above mentioned problem in the water washing step of the wet process manufacturing method.

The embodiment according to the invention has been done in view of the above described problems.

An object of the embodiment according to the invention is to provide a method of manufacturing a composite film, which method is capable of manufacturing a composite film having a high quality at a high production efficiency.

Specific means to solve the above-described problem include the followings.

[1] A method of manufacturing a composite film, the method comprising:

a coating step comprising coating a coating liquid containing a resin on one surface or both surfaces of a porous substrate to form a coating layer, the porous substrate having a tensile strength at 2% elongation in a machine direction of 0.3 N/cm or more;

a solidification step comprising solidifying the resin by bringing the coating layer into contact with a solidifying liquid to obtain a composite film comprising the porous substrate and a porous layer that is formed on one surface or both surfaces of the porous substrate and that comprises the resin; and

a water wishing step comprising washing the composite film with water by transporting the composite film at a transport speed of 30 m/min or more in a water washing tank;

the water washing tank comprising two or more drive rolls for supporting and transporting the composite film, and a path length between any two adjacent drive rolls being from 0.5 m to 5 m.

[2] The method of manufacturing a composite film according to [1], wherein at least one of the drive rolls includes a groove on an outer circumferential surface thereof.

[3] The method of manufacturing a composite film according to [1] or [2,] wherein in the water washing tank, at least one of spaces between the drive rolls is provided with at least one driven roll for supporting the composite film, and a total rotational resistance of the at least one driven roll disposed between two adjacent drive rolls is 50 g or less.

[4] The method of manufacturing a composite film according to any one of [1] to [3], wherein the porous substrate has a thickness of from 5 μm to 50 μm.

[5] The method of manufacturing a composite film according to any one of [1] to [4], wherein the porous substrate has an elongation at break in the machine direction of 10% or more.

### Effects of Invention

According to an embodiment of the invention, a method of manufacturing a composite film, which is capable of manufacturing a composite film having a high quality at a high production efficiency, is provided.

### BRIEF DESCRIPTION OF DRAWINGS

FIG. 1 is a schematic diagram illustrating one embodiment of the method of manufacturing of the present disclosure.

FIG. 2 is a schematic view illustrating one example of a water washing tank for performing a water washing step in the method of manufacturing of the present disclosure.

FIG. 3A is a perspective view showing an example of a roll having grooves on an outer circumferential surface thereof.

FIG. 3B is a perspective view showing an example of a roll having grooves on an outer circumferential surface thereof.

FIG. 3C is a perspective view showing an example of a roll having grooves on an outer circumferential surface thereof.

FIG. 3D is a perspective view showing an example of a roll having grooves on an outer circumferential surface thereof.

FIG. 3E is a perspective view showing an example of a roll having grooves on an outer circumferential surface thereof.

FIG. 4A is a schematic diagram for explaining a “path length between any two adjacent drive rolls”.

FIG. 4B is a schematic diagram for explaining a “path length between any two adjacent drive rolls”.

FIG. 5A is a schematic view illustrating a water washing tank used in Example 1.

FIG. 5B is a schematic view illustrating a water washing tank used in Example 2.

FIG. 5C is a schematic view illustrating a water washing tank used in Example 3.

FIG. 5D is a schematic view illustrating a water washing tank used in Comparative Example 1.

### DESCRIPTION OF EMBODIMENTS

The value range shown using the expression “from . . . to . . . ” in this specification is a range including values described before and after the term “to” as a minimum value and a maximum value, respectively.

In this specification, the term “step” refers not only to an independent step, but also to a step that cannot be clearly distinguished from other steps as long as an expected action of the step is achieved.

In this specification, the “machine direction” means a long direction of a long separator, and the “transverse direction” means a direction orthogonal to the longitudinal direction of the separator. The “machine direction” is also referred to as a “MD direction”, and the “transverse direction” is also referred to as a “TD direction”.

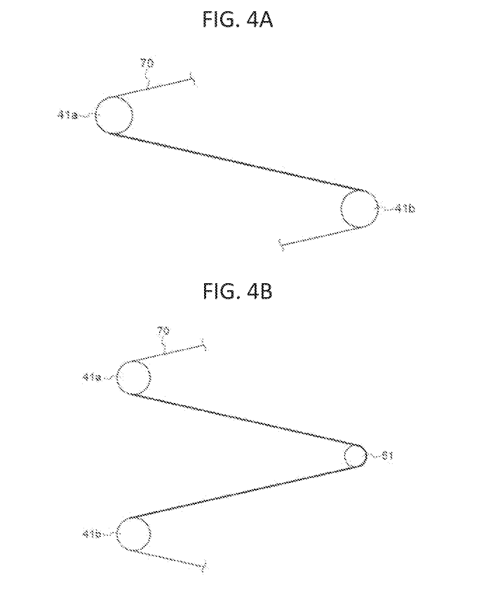

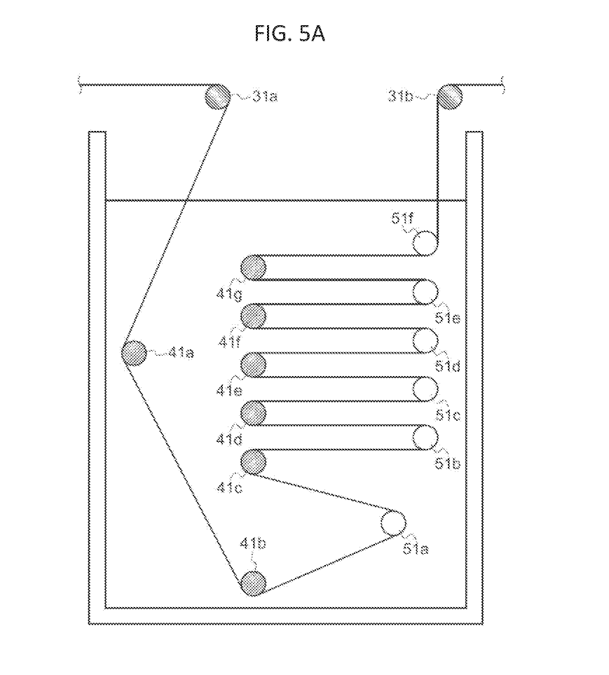

The expression “path length between any two adjacent drive rolls” as used in the present specification will be described with reference to FIG. 4A and FIG. 4B. FIGS. 4A and 4B schematically show positional relationships between the drive rolls, and between the drive rolls and a driven roll, respectively, provided in a water washing tank.

In FIG. 4A, a drive roll 41a and a drive roll 41b are disposed in this order, from an upstream side to a downstream side in a transport direction of a composite film 70. In this case, the “path length between any two adjacent drive rolls” refers to a distance between a point at which the composite film 70 comes out of contact with the drive roll 41a and a point at which the composite film 70 comes into contact with the drive roll 41b (a length of a line indicated with a bold line).

In FIG. 4B, the drive roll 41a, a driven roll 51, and the drive roll 41b are disposed in this order, from the upstream side to the downstream side in the transport direction of the composite film 70. In this case, as well, the “path length between any two adjacent drive rolls” refers to the distance between the point at which the composite film 70 comes out of contact with the drive roll 41a and the point at which the composite film 70 comes into contact with the drive roll 41b (the length of a line indicated with a bold line). This also applies to a case in which two or more driven rolls are interposed between two adjacent drive rolls.

Hereinafter, an embodiment of the invention will be described. The descriptions and examples are intended to illustrate the invention, and are not intended to limit the scope of the invention.

<Method of Manufacturing Composite Film>

The method of manufacturing a composite film according to the present disclosure is a method of manufacturing a composite film including: a porous substrate; and a porous layer formed on one surface or both surfaces of the porous substrate, and containing a resin. The manufacturing method according to the present disclosure is a method in which a coating liquid containing a resin is coated on one surface or both surfaces of a porous substrate, to form a porous layer on one surface or both surfaces of the porous substrate. The manufacturing method according to the present disclosure includes the following steps.
Coating step: a step of coating the coating liquid containing a resin on one surface or both surfaces of a porous substrate, to form a coating layer.
Solidification step: a step of solidifying the resin contained in the coating layer by contacting the coating layer to a solidifying liquid, to obtain a composite film including the porous substrate and a porous layer formed on one surface or both surfaces of the porous substrate, and containing the resin.
Water washing step: a step of washing the composite film with water by transporting the composite film in a water washing tank.

The manufacturing method according to the present disclosure is a method which includes providing a porous layer by a process which is so-called a wet process.

The manufacturing method according to the present disclosure may further include a drying step of removing water from the composite film, after the water washing step. The manufacturing method according to the present disclosure may further include a coating liquid preparation step of preparing a coating liquid to be used in the coating step.

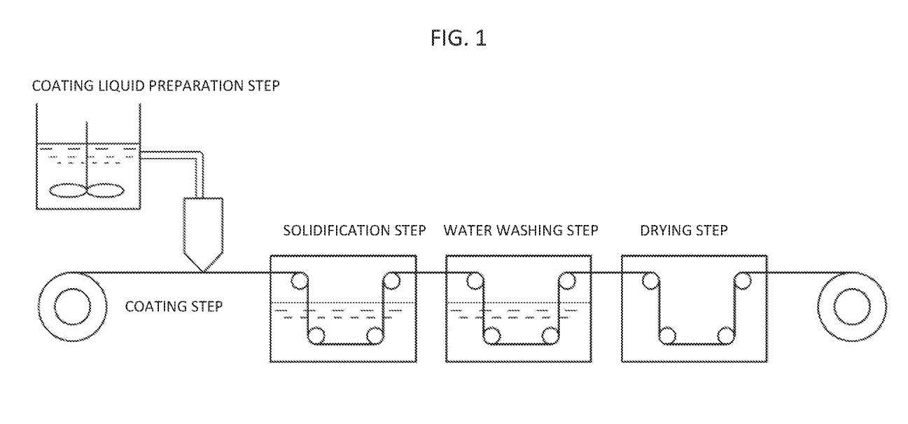

FIG. 1 is a schematic diagram showing one embodiment of the manufacturing method according to the present disclosure. In FIG. 1, a roll of the porous substrate to be used in the production of the composite film is shown on the left side in the figure, and a roll around which the resulting composite film is wound is shown on the right side in the figure. The embodiment shown in FIG. 1 includes the coating liquid preparation step, the coating step, solidification step, the water washing step, and the drying step. In the present embodiment, the coating step, the solidification step, the water washing step, and the drying step are carried out continuously and sequentially. Further, in the present embodiment, the coating liquid preparation step is carried out at time points suitable for carrying out the coating step. Details regarding the respective steps will be described later.

In the manufacturing method according to the present disclosure, the composite film is transported in the water washing tank at a transport speed of 30 m/min or more in the water washing step, in terms of the production efficiency of the composite film. Based on the above, in the manufacturing method according to the present disclosure, the porous substrate to be used in the manufacture of the composite film has a tensile strength at 2% elongation in the MD direction of 0.3 N/cm or more, the water washing tank to be used in the water washing step includes two or more drive rolls for supporting and transporting the composite film, and each of the path length(s) between two adjacent the drive rolls is from 0.5 m to 5 m. The manufacturing method according to the present disclosure is capable of manufacturing a composite film having a high quality at a high production efficiency. The mechanism thereof is not necessarily clear, but is suspected to be as follows.

In the water washing step, it is necessary to apply a tensile force to the composite film in the transport direction, since the composite film is transported against the resistance of water. However, too high tensile force causes the composite film to be stretched, and as a result, composite film may be elongated. In particular, when the transport speed of the composite film is increased in order to improve the production efficiency, the composite film is more likely to be elongated. When a transport tension is decreased in order to prevent the elongation, on the other hand, wrinkles are more likely to occur in the composite film. Therefore, the elongation and the wrinkles are in a trade-off relationship. Further, too high or too low transport tension may cause peeling of the coating layer from the composite film.

To cope with this phenomenon, in the manufacturing method according to the present disclosure, the path lengths between any two adjacent drive rolls included in the water washing tank is adjusted to be 5 m or less, so that the resistance of water against the composite film can be distributed. As a result, it is possible to reduce the tensile force to be applied to composite film in the transport direction, thereby preventing the occurrence of elongation, wrinkles, and peeling in the composite film. In addition, since a porous substrate having a tensile strength at 2% elongation in the MD direction of 0.3 N/cm or more is used in the manufacturing method according to the present disclosure, the resulting composite film is prevented from being elongated in the MD direction during the transport in the water washing step. Further, since the path length between any two adjacent drive rolls included in the water washing tank is 0.5 m or more, in the manufacturing method according to the present disclosure, it is possible to prevent the composite film from meandering, thereby improving the quality of the composite film.

Therefore, according to the manufacturing method of the present disclosure, a composite film having a high quality at a high production efficiency can be manufactured.

The respective steps in the manufacturing method according to the present disclosure will now be described in detail.

[Coating Liquid Preparation Step]

The manufacturing method of the present disclosure may include a coating liquid preparation step, which is a step for preparing a coating liquid used in the coating step. The manufacturing method of the present disclosure can be a method which does not include the coating liquid preparation step, and a coating liquid which is manufactured in advance and stored can be used in the coating step therefor.

The coating liquid preparation step is a step for preparing a coating liquid containing a resin. The coating liquid is prepared, for example, by dissolving a resin in a solvent, and by further dispersing an inorganic filler or an organic filler in the resultant if necessary. Details regarding the resin, the filler and the like used in the preparation of the coating liquid, namely, the resin and the filler contained in the porous layer, will be described in the section of “Porous Layer” to be described later.

Examples of the solvent to be used for dissolving the resin in the preparation of the coating liquid (hereinafter, also referred to as “good solvent”) include a polar amide solvent such as N-methylpyrrolidone, dimethylacetamide, dimethylformamide, and dimethylformamide. In terms of forming a porous layer having a favorable porous structure, it is preferable to add and mix a phase separating agent for inducing phase separation, in addition to the good solvent. Examples of the phase separating agent include water, methanol, ethanol, propyl alcohol, butyl alcohol, butanediol, ethylene glycol, propylene glycol, and tripropylene glycol. It is preferable that the phase separating agent is added and mixed with the good solvent to the extent that the resulting coating liquid has a viscosity suitable for the coating.

The solvent to be used in the preparation of the coating liquid is preferably a mixed solvent containing 60% by mass or more of the good solvent, and from 5% by mass to 40% by mass of the phase separating agent, in terms of forming a favorable porous structure. It is preferable that the coating liquid contains a resin in a concentration of from 3% by mass to 15% by mass in terms of forming a favorable porous structure.

[Coating Step]

The coating step is a step of coating the coating liquid containing a resin on one surface or both surfaces of a porous substrate, to form a coating layer. The coating of the coating liquid on the porous substrate is carried out by a coating means such as a Meyer bar, a die coater, a reverse roll coater, or a gravure coater. A total amount of the coating liquid to be coated on both surfaces is, for example, from 10 mL/m² to 60 mL/m².

One embodiment of the coating step is an embodiment in which the coating liquid is simultaneously coated on both surfaces of the porous substrate, using a first coating means for coating one surface of the porous substrate, and a second coating means for coating the other surface of the porous substrate, which coating means are disposed so as to face each other with the porous substrate interposed therebetween.

One embodiment of the coating step is an embodiment in which the coating liquid is coated on both surfaces of the porous substrate by coating one surface at a time in sequence, using the first coating means for coating one surface of the porous substrate, and the second coating means for coating the other surface of the porous substrate, which coating means are disposed spaced apart from each other in a transport direction of the porous substrate.

[Solidification Step]

The solidification step is a step in which the coating layer is brought into contact with a solidifying liquid to solidify the resin contained in the coating layer, thereby obtaining a composite film having a porous layer on one surface or both surfaces of a porous substrate. The contacting of the coating layer to a solidifying liquid is preferably performed by making the coating layer pass through a tank containing a solidifying liquid (solidification tank). Examples of the solidification tank used for immersing the porous substrate having the coating layer include one that is similar to a water washing tank to be used in the water washing step.

The solidifying liquid to be used in the wet process is generally a mixture of a good solvent and a phase separating agent used in the preparation of the coating liquid, and water. A mixing ratio of the good solvent and the phase separating agent is preferably the same as the mixing ratio of the mixed solvent used in the preparation of the coating liquid, in terms of production. A content of water in the solidifying liquid is preferably from 40% by mass to 80% by mass with respect to the total amount of the solidifying liquid, in terms of formability of the porous structure and productivity. The temperature of the solidifying liquid may be, for example, from 10° C. to 50° C.

[Water Washing Step]

The water washing step is a step which is performed by transporting the composite film through a water bath for the purpose of removing solvents contained in the composite film (the solvent used in the coating liquid and the solvent used in the solidifying liquid).

The transport speed of the composite film in the water washing tank in the water washing step is 30 m/min or more, in terms of the production efficiency of the composite film. The transport speed is more preferably 40 m/min or more, and still more preferably 50 m/min or more. At the same time, an upper limit of the transport speed is preferably 200 m/min or less, in terms of preventing the peeling of the porous layer.

The tensile force applied to the composite film in the transport direction in the water washing step is preferably from 30 N/m to 500 N/m, for example.

A time for washing the composite film with water (the period of time during which the composite film is immersed under water) is set to be sufficient for the solvent remaining in a final product of the composite film to be equal to or less than a predetermined concentration. The water-washing time of the composite film can be controlled by adjusting a transport length under water and the transport speed of the composite film. The concentration (on a mass basis) of the solvent remaining in the final product of the composite film is preferably 1,000 ppm or less.

One or more water washing tank(s) may be used for carrying out the water washing step. The number of the water washing tanks is preferably two or more, in terms of efficiently removing the solvent from the composite film.

Exemplary embodiments of the water washing tank will now be described with reference to drawings. However, the manufacturing method according to the present disclosure is in no way limited by these embodiments.

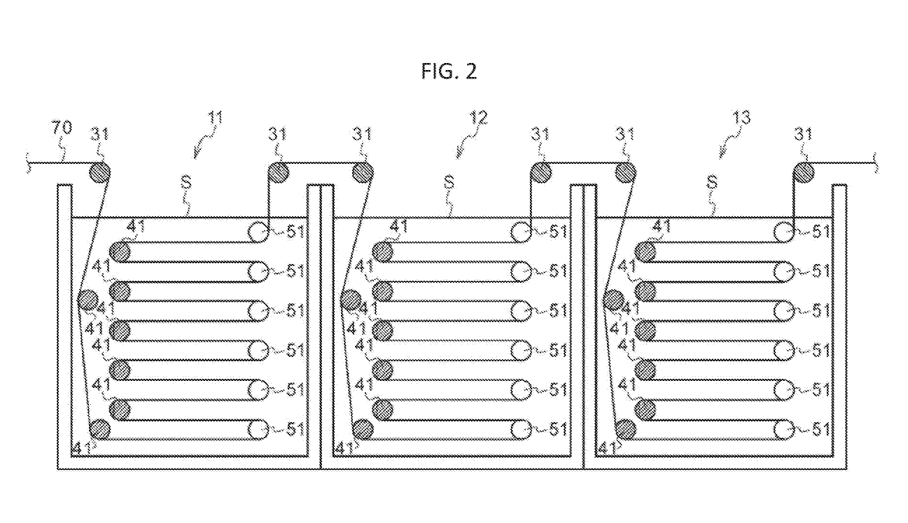

In an exemplary embodiment shown in FIG. 2, a water washing tank 11, a water washing tank 12, and a water washing tank 13 are disposed in this order, from the upstream side to the downstream side in the transport direction of the composite film 70. The water washing tank 11, the water washing tank 12, and the water washing tank 13 are disposed, for example, at the same height on a linear line connecting between the solidification step and the drying step. The water washing tank 11, the water washing tank 12, and the water washing tank 13 may be, for example, in the shape of a rectangular parallelepiped.

It is preferable that the transport length under water of the composite film in each of the water washing tank 11, the water washing tank 12, and the water washing tank 13 is from 1 m to 20 m, and more preferably from 2 m to 10 m. A total transport length under water of the composite film in all of the one or more water washing tank(s) is preferably from 4 m to 100 m, and more preferably from 10 m to 40 m. The transport length under water in each of the water washing tanks, and the total transport length under water in all of the one or more water washing tank(s) are preferably adjusted depending on the transport speed of the composite film.

Since the water washing tank 11, the water washing tank 12, and the water washing tank 13 have the same shapes, a description will be given below regarding the water washing tank 11, as a representative example.

The water washing tank 11 shown in FIG. 2 includes: drive rolls 31, drive rolls 41, and the driven rolls 51, for transporting the composite film 70.

The drive rolls 31 are disposed at an upper side at an exterior of the water washing tank 11 (namely, at positions higher than a water surface of the water washing tank 11 when the tank is fully filled), one each at the upstream side and the downstream side of the water washing tank 11. The drive rolls 41 are disposed in an interior of the water washing tank 11 (namely, at positions lower than the water surface of the water washing tank 11 when the tank is fully filled). The drive rolls 31 and the drive rolls 41 are provided for supporting and transporting the composite film 70. Rotational velocities of the drive rolls 31 and the drive rolls 41 are controlled by a motor and a control section, which are not shown in the figure. The driven rolls 51 are provided for supporting the composite film 70. The driven rolls 51 are capable of free rotation, and are rotated as the composite film 70 is transported by a transport force provided by the drive rolls.

In the embodiment shown in FIG. 2, the drive rolls 31, the drive rolls 41, and the driven rolls 51 are arranged such that the composite film 70 is stepwisely transported upward from a bottom side to the side of a water surface S of the water washing tank 11. However, the arrangement of these rolls is not limited to the present embodiment. In another embodiment, the drive rolls 31, the drive rolls 41, and the driven rolls 51 are arranged such that the composite film 70 is stepwisely transported downward from the side of the water surface S to the bottom side of the water washing tank 11. In still another embodiment, the drive rolls 31, the drive rolls 41, and the driven rolls 51 are arranged such that the composite film 70 is reciprocated upward and downward between the bottom side and the side of the water surface S of the water washing tank 11.

The transport length under water of the composite film in the water washing tank 11 can be controlled by adjusting a total number and positions of the drive rolls 31, the drive rolls 41, and the driven rolls 51 to be disposed.

The water washing tank 11 need not be fully filled, and the transport length under water can also be adjusted by changing a level of water in the water washing tank 11. The level of water in the water washing tank 11 may be changed, as the water washing step proceeds.

In the water washing tank 11, the drive rolls 31 are not necessary provided, and the drive rolls 41 are also not necessary provided. The water washing tank 11 needs to include at least two rolls selected from the drive rolls 31 and the drive rolls 41. When at least two of the drive rolls 41 are disposed in the water washing tank 11, for example, the drive rolls 31 disposed at the upstream side and the downstream side of the tank may be replaced by the driven rolls 51. When the drive rolls 31 are disposed at least one each at the upstream side and at the downstream side of the water washing tank 11, for example, the drive rolls 41 may be replaced by the driven rolls 51. When at least one drive roll 31 is disposed at the upstream side of the water washing tank 11, and at least one drive roll 41 is disposed in the water washing tank 11, for example, the drive roll 31 at the downstream side of the water washing tank 11 may be replaced by the driven roll 51. Further, when at least one drive roll 31 is disposed at the downstream side of the water washing tank 11, and at least one drive roll 41 is disposed in the water washing tank 11, for example, the drive roll 31 at the upstream side of the water washing tank 11 may be replaced by the driven roll 51.

The water washing tank 11 preferably includes at least one drive roll 31 at the upstream side of the tank, at least one drive roll 41 in the interior thereof, and at least one drive roll 31 at the downstream side thereof, in terms of stably transporting the composite film 70.

In a case in which the drive roll(s) 31 is/are disposed at the upstream side of the water washing tank 11, a number thereof is not limited, and one or more drive roll(s) 31 may be disposed, while one is preferred. In a case in which the drive roll(s) 31 is/are disposed at the downstream side of the water washing tank 11, a number thereof is not limited, and one or more drive roll(s) 31 may be disposed, while one is preferred. In a case in which the drive roll(s) 41 is/are disposed in the water washing tank 11, a number thereof is not limited, and one or more drive roll(s) 31 may be disposed.

The driven rolls 51 are not essential, and need not be provided. Further, one or more driven roll(s) 51 may be disposed between two adjacent drive rolls 41, and one or more driven roll(s) 51 may be disposed between the drive roll 31 and the drive roll 41, for example. In other words, the number of the driven rolls 51 interposed between two adjacent drive rolls may be zero, one, or two or more. In terms of preventing the occurrence of elongation and wrinkles in the composite film, the smaller the number of the driven rolls 51 interposed between two adjacent drive rolls, the more preferred.

In a case in which the water washing tank 11 includes two or more drive rolls 41, one part of the two or more drive rolls 41 may be immersed under water, and the other part of the two or more drive rolls 41 may be exposed in the air. The same applies for the driven rolls 51. Further, each of the drive rolls 41 and the driven rolls 51 need not be entirely immersed under water, and a part of the rolls may be exposed in the air.

The path length between any two adjacent drive rolls is 5.0 m or less, and more preferably 4.0 m or less, and still more preferably 3.0 m or less, in terms of preventing the occurrence of elongation and wrinkles in the composite film 70. At the same time, the path length is 0.5 m or more, and more preferably 1.0 m or more, in terms of preventing the composite film 70 from meandering, and thereby improving the quality of the composite film. In the embodiment shown in FIG. 2, the path length between any two adjacent drive rolls refers to a path length between the drive roll 31 at the upstream side and the drive roll 41 immediately downstream of this drive roll 31, the path length between the drive roll 31 at the downstream side and the drive roll 41 immediately upstream of this drive roll 31, or the path length between any two adjacent drive rolls 41. For example, in an embodiment in which all the drive rolls 41 shown in FIG. 2 are replaced by the driven rolls 51, the path length between the drive roll 31 at the upstream side and the drive roll 31 at the downstream side is the path length between any two adjacent drive rolls, which path length is from 0.5 m to 5.0 m.

The path length between any two adjacent drive rolls is preferably increased or decreased depending on the tensile strength at 2% elongation in the MD direction of the porous substrate. When the porous substrate has a higher tensile strength at 2% elongation, the path length may be longer.

In a case in which three or more drive rolls are disposed in water washing tank 11, the respective path lengths between two adjacent drive rolls may be the same as or different from each other.

In the water washing tank 11, the path length between any two adjacent drive rolls 41 is preferably shorter than the path length between the drive roll 31 and adjacent drive roll 41.

The driven roll(s) 51 is/are preferably disposed at position(s) which divide(s) the path length between any two adjacent drive rolls into equal distances. For example, in a case in which one driven roll 51 is disposed between two adjacent drive rolls 41, as shown in FIG. 2, the one driven roll 51 is preferably disposed at a position which divides the path length between the two adjacent drive rolls 41 into two equal distances.

The path length between one drive roll (the drive roll 31 or the drive roll 41) and one driven roll 51 adjacent thereto (the distance of a linear line from the point at which the composite film comes out of contact with the roll at upstream, until the point at which the composite film comes into contact with the roll at downstream) is preferably from 0.5 m to 2.5 m, and more preferably from 1.0 m to 2.0 m.

In a case in which the driven roll(s) 51 is/are disposed, a total rotational resistance of the driven roll(s) 51 interposed between two adjacent drive rolls is preferably 50 g or less, and more preferably 20 g or less, in terms of reducing a load applied to the drive rolls. The rotational resistance (g) per one driven roll is preferably 20 g or less.

The rotational resistance (g) of the driven roll 51 refers to the load (g) at which the roll at rest starts to rotate, which load is measured by the following method.

A roll is disposed in the air so as to be capable of free rotation. At this time, the roll is disposed such that an axial direction of the roll matches a horizontal direction. A thread is wound around the roll at a center in the width direction thereof, and one end of the thread is allowed to hang down in the direction of gravity. A length of the thread to be used may be selected depending on a thickness of the roll. The thread is wound once around the roll along the roll surface, and tied. Then the thread is wound again, twice or so, starting from the tied point, and one end of the thread may be allowed to hang down in the direction of gravity. Then a load is gradually applied at the one end of the thread hanging down in the direction of gravity, and the load (g) at which the roll at rest starts to rotate is measured. This measurement is carried out at an environment of a temperature of 20° C.

Each of the drive rolls 31, the drive rolls 41, and the driven rolls 51 preferably has an outer diameter of from 1 cm to 50 cm and a width of from 10 cm to 300 cm.

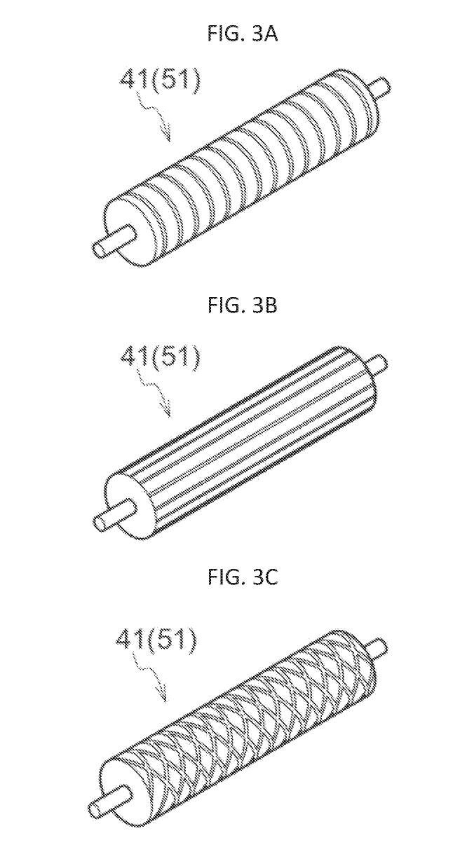

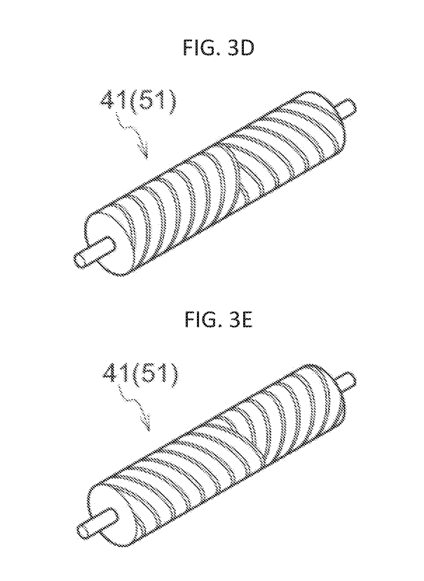

Each of the drive rolls 41 and the driven rolls 51 preferably has grooves on an outer circumferential surface thereof, such as any of the rolls shown in FIG. 3A to FIG. 3E. Each of the drive rolls 31, which are disposed in the air, may also have grooves on an outer circumferential surface thereof. The presence or absence of grooves, and the shape thereof when present, on the outer circumferential surface of each of the rolls may be selected depending on the thickness and the tensile strength of the porous substrate, materials of the coating layer, and the transport speed of the composite film.

FIG. 3A to FIG. 3E are perspective views each showing an example of a roll having grooves on an outer circumferential surface thereof. In the roll shown in FIG. 3A, grooves each extending around the roll in a circumferential direction thereof are arranged spaced apart from each other at predetermined intervals in the width direction. In the roll shown in FIG. 3B, grooves each extending from one end of the roll in the width direction to the other end thereof, and parallel in the width direction, are arranged spaced apart from each other at predetermined intervals in the circumferential direction. In the roll shown in FIG. 3C, a right-handed helical groove and a left-handed helical groove each extending from one end of the roll in the width direction to the other end thereof, are provided. In each of the rolls shown in FIG. 3D and FIG. 3E, a right-handed helical groove extending from one end of the roll in the width direction to the center thereof, and a left-handed helical groove extending from the other end of the roll in the width direction to the center thereof, are provided.

The grooves provided on the outer circumferential surfaces of the rolls shown in FIG. 3A to FIG. 3E have, for example, a width of from 0.1 mm to 5 mm and a depth of 0.01 mm or more, and are provided at intervals of from 1 mm to 100 mm. Each groove may be formed in the shape (the shape of the cross section when a surface layer of the roll is cut in the direction of the thickness of the layer and in the width direction of the groove) of, for example, a column, a cone, a taper, or a reverse taper.

In a case in which each of the drive rolls 41 has grooves on the outer circumferential surface thereof, as any one of the rolls shown in FIG. 3A to FIG. 3E, drainage of water entrapped between the drive rolls 41 and the composite film 70 is facilitated, and the transportation of the composite film 70 by the drive rolls 41 can be reliably performed.

In a case in which each of the driven rolls 51 has grooves on the outer circumferential surface thereof, as any one of the rolls shown in FIG. 3A to FIG. 3E, the drainage of water entrapped between the driven rolls 51 and the composite film 70 is facilitated, and the composite film 70 is prevented from being dislocated from the driven rolls 51.

Examples of materials for the outer circumferential surfaces of the drive rolls 31, the drive rolls 41, and the driven rolls 51 include stainless steels, metal plating, ceramics, silicone rubbers, and fluororesins.

The water washing tank 11 may include a device which removes an entrained liquid of the composite film 70, from the composite film 70, at the upper side at the exterior of the water washing tank, at the upstream side and/or the downstream side thereof. The device which removes the entrained liquid of the composite film 70 may be, for example, a nip roll, an air nozzle, a scraper or the like.

A temperature of water contained in the water washing tank 11 is, for example, from 0° C. to 70° C. The temperature of the water is preferably 10° C. or higher, more preferably 15° C. or higher, and still more preferably 20° C. or higher, in terms of efficiently removing the solvent from the composite film. At the same time, the temperature of the water is preferably 60° C. or lower, more preferably 50° C. or lower, and still more preferably 40° C. or lower, in terms of production cost.

As the water washing step proceeds, the solvent contained in the coating layer is dissolved into water in the water washing tank 11, to cause an increase in a concentration of the solvent in the water. Therefore, the water in the tank is preferably replaced continuously or intermittently, in terms of preventing increase in the concentration of the solvent in the water, and enhancing efficiency of removal of the solvent from the composite film. The concentration (on a mass basis) of the solvent contained in the water in the water washing tank 11 is preferably controlled within a range of from 100 ppm to 50%. In a case in which two or more water washing tanks are used, it is preferable to adjust the concentrations of the solvent in the respective tanks such that the water in a water washing tank closer to the downstream side in the transport direction of the composite film has a lower concentration of the solvent. In other words, the concentrations of the solvent in the water in the respective water washing tanks are controlled such that, the water in the water washing tank 12 has a lower solvent concentration than that of the water washing tank 11, and the water in the water washing tank 13 has a lower solvent concentration than that of the water washing tank 12.

[Drying Step]

The method of manufacturing a composite film according to the present disclosure preferably includes a drying step of removing water from the composite film after the water washing step. The method of drying is not particularly limited. Examples thereof include: a method in which the composite film is brought into contact with a heat-generating member: a method in which the composite film is transported into a chamber controlled at a certain temperature and humidity; and a method in which hot air is applied to the composite film. In a case in which heat is applied to the composite film, the temperature of the heat is, for example, from 50° C. to 80° C.

The manufacturing method according to the present disclosure may employ the following embodiments.
As a part of the coating liquid preparation step, the solvent for preparing the coating liquid is subjected to a treatment in which the solvent is passed through a filter before being mixed with a resin, in order to remove foreign substances therefrom. The filter to be used in this treatment has a retainable particle diameter of, for example, from 0.1 μm to 100 μm.
An agitator is provided in a tank in which the coating liquid preparation step is carried out, and the coating liquid is constantly stirred with the agitator to prevent precipitation of solid components (such as a filler) in the coating liquid.
A piping for transporting the coating liquid from the coating liquid preparation step to the coating step is arranged in a circular system, and the coating liquid is circulated within the piping to prevent aggregation of solid components in the coating liquid. In this case, it is preferable that a temperature of the coating liquid in the piping is controlled to be constant.
A filter is provided in a middle of a piping for transporting the coating liquid from the coating liquid preparation step to the coating step to remove aggregates and/or foreign substances in the coating liquid.
A non-pulsating metering pump is provided as a pump for supplying the coating liquid from the aggregate removal step to the coating step.
A static elimination device is provided upstream of the coating step, for destaticizing the surface of the porous substrate.
A housing is provided around a coating means, to maintain clean the environment in which the coating step is carried out, and to control a temperature and humidity of the atmosphere in the coating step.
A sensor for detecting an amount of the coating liquid coated is provided downstream of the coating means, to correct the coated amount in the coating step.

The porous substrate and the porous layer included in the composite film will now be described in detail.

[Porous Substrate]

The porous substrate refers to a substrate which includes pores or cavities in the interior thereof. Examples of such a substrate include: a microporous film: a porous sheet composed of a fibrous product such as a nonwoven fabric or a paper; and a composite porous sheet obtained by layering one or more other porous layers on the microporous film or the porous sheet as described above. In the present disclosure, a microporous film is preferred, in terms of obtaining a thinner and stronger composite film. The microporous film refers to a film which includes a number of micropores in the interior thereof, and has a structure in which these micropores are connected, so that a gas or a liquid is able to pass therethrough from one surface to the other surface of the film.

A material as a component of the porous substrate is preferably a material having an electrical insulating property, and may be either an organic material or an inorganic material.

The material as a component of the porous substrate is preferably a thermoplastic resin, in terms of imparting a shutdown function to the porous substrate. The shutdown function refers to a function, in a case in which the composite film is used as a battery separator, in which the component material is melted to clog the pores of the porous substrate, when the temperature of the battery is increased, thereby blocking ion migration and preventing a thermal run away of the battery. The thermoplastic resin is suitably a thermoplastic resin having a melting temperature of less than 200° C., and particularly preferably a polyolefin.

The porous substrate is preferably a microporous film containing a polyolefin (hereinafter, also referred to as “polyolefin microporous film). Examples of the polyolefin microporous film include polyolefin microporous films used in conventional battery separators. Among these, one having favorable mechanical properties and substance permeability can be preferably selected.

The polyolefin microporous film preferably contains one or both of polyethylene in terms of exhibiting the shutdown function. A content of polyethylene in the polyolefin microporous film is preferably 95% by mass or more with respect to a total mass of the polyolefin microporous film.

The polyolefin microporous film is preferably a polyolefin microporous film containing polyethylene and polypropylene, since such a film has a heat resistance sufficient for preventing the film from easily rupturing when exposed to a high temperature. Examples of the polyolefin microporous film as described above include a microporous film in which polyethylene and polypropylene coexist within one layer. The microporous film as described above preferably contains 95% by mass or more of polyethylene and 5% by mass or less of polypropylene, in terms of obtaining both the shutdown function and the heat resistance in a balanced manner. Further, in terms of obtaining both the shutdown function and the heat resistance in a balanced manner, the microporous film is preferably a polyolefin microporous film having a laminated structure composed of two or more layers, in which at least one layer contains polyethylene and at least one layer contains polypropylene.

The polyolefin included in the polyolefin microporous film suitably has a weight-average molecular weight of from 100,000 to 5,000,000. When the polyolefin has a weight-average molecular weight of greater than 100,000, sufficient mechanical properties can be imparted to the microporous film. When the polyolefin has a weight-average molecular weight of less than 5,000,000, the microporous film has a favorable shut down property, and the film formation of the microporous film can be carried out easily.

Examples of manufacturing the polyolefin microporous film include: a method in which a melted polyolefin resin is extruded from a T-die to be formed into a sheet. The resultant is subjected to a crystallization treatment, followed by stretching, and then further subjected to a heat treatment, thereby obtaining a microporous film; and a method in which a polyolefin resin melted along with a plasticizer, such as liquid paraffin, is extruded from a T-die, the resultant is cooled to be formed into a sheet, stretching the resulting sheet, the plasticizer is extracted therefrom, and the resultant is subjected to a heat treatment, thereby obtaining a microporous film.

Examples of the porous sheet composed of a fibrous product include porous sheets, such as nonwoven fabrics and papers, composed of fibrous products such as: polyesters such as polyethylene terephthalate; polyolefins such as polyethylene and polypropylene; heat resistant resins such as aromatic polyamides, polyimides, polyethersulfones, polysulfones, polyether ketones, and polyetherimides; and celluloses. The heat resistant resin refers to a resin having a melting temperature of 200° C. or higher, or a resin which does not have a melting temperature and has a decomposition temperature of 200° C. or higher.

Examples of the composite porous sheet include one that has a structure in which a functional layer(s) is/are layered on a porous sheet composed of a microporous film or a fibrous product. Such a composite porous sheet is preferred, because the functional layer(s) included therein allow(s) for imparting an additional function(s). In terms of imparting heat resistance, for example, a porous layer composed of a heat resistant resin, or a porous layer composed of a heat resistant resin and an inorganic filler can be used as the functional layer. The heat resistant resin may be, for example, one kind or two or more kinds of heat resistant resins selected from aromatic polyamides, polyimides, polyethersulfones, polysulfones, polyether ketones or polyetherimides. Examples of the inorganic filler include a metal oxide such as an alumina and a metal hydroxide such as magnesium hydroxide. The composite porous sheet having the above structure may be formed, for example, by: a method in which a functional layer is coated on a microporous film or a porous sheet; a method in which a microporous film or a porous sheet and a functional layer are bonded with an adhesive agent; and a method in which a microporous film or a porous sheet and a functional layer are bonded by thermocompression bonding.

The porous substrate preferably has a width of from 0.1 m to 3.0 m, in terms of compatibility with the manufacturing method according to the present disclosure.

The porous substrate preferably has a thickness of from 5 μm to 50 μm.

A tensile strength at 2% elongation of the porous substrate in the MD direction is 0.3 N/cm or more, preferably 1 N/cm or more, and more preferably 2 N/cm or more. The tensile strength at 2% elongation in an MD direction is preferably 20 N/cm or less in terms of equipment protection.

The porous substrate preferably has an elongation at break in the MD direction of 10% or more in terms of mechanical strength.

The tensile strength at 2% elongation and the elongation at break of the porous substrate are obtained by carrying out a tensile test in an atmosphere at a temperature of 20° C., using a tensile tester, at a tensile speed of 100 mm/min.

The porous substrate preferably has a Gurley value (JIS P8117 (2009)) of 50 sec/100 cc to 800 sec/100 cc, in terms of the mechanical strength and the substance permeability.

The porous substrate preferably has a porosity of 20% to 60%, in terms of the mechanical strength, handling property, and the substance permeability.

The porous substrate preferably has an average pore diameter of from 20 nm to 100 nm, in terms of the substance permeability. The average pore diameter as used herein refers to a value measured using a palm porometer, in accordance with ASTM E1294-89.

[Porous Layer]

The porous layer refers to a layer which includes a number of micropores in the interior thereof, and has a structure in which these micropores are connected, so that a gas or a liquid is able to pass therethrough from one surface to the other surface of the film.

In a case in which the composite film is used as a battery separator, the porous layer is preferably an adhesive porous layer capable of adhering to an electrode. It is more preferable that the adhesive porous layer is provided on both surfaces of the porous substrate, rather than being provided on only one surface of the porous substrate.

The porous layer is formed by coating a coating liquid containing a resin. Accordingly, the porous layer contains a resin. The porous layer is preferably formed by coating a coating liquid containing a resin and a filler in terms of porosifying the porous layer. Therefore, the porous layer preferably contains a resin and a filler. The filler may be either an inorganic filler or an organic filler. The filler is preferably inorganic particles, in terms of porosifying the porous layer and of heat resistance. A description will now be given below regarding the porous layer, and the components, such as a resin, contained in the coating liquid and the porous layer.

[Resin]

A type of the resin to be contained in the porous layer is not limited. The resin to be contained in the porous layer is preferably a resin (so-called binder resin) having a function to bind particles of a filler. In terms of compatibility to the wet process, the resin to be contained in the porous layer is preferably a hydrophobic resin, in terms of production compatibility. In a case in which the composite film is used as a battery separator, the resin to be contained in the porous layer is preferably a resin which is stable in an electrolyte solution, which is electrochemically stable, which has a function of binding inorganic particles, and which is capable of adhering to an electrode. The porous layer may contain one kind of resin, or two or more kinds of resins.

Examples of the resin to be contained in the porous layer is preferably polyvinylidene fluoride, a polyvinylidene fluoride copolymer, a styrene-butadiene copolymer, a homopolymer or a copolymer of a vinyl nitrile such as acrylonitrile or methacrylonitrile, or a polyether such as polyethylene oxide or polypropylene oxide. Of these, polyvinylidene fluoride and a polyvinylidene fluoride copolymer (, referred to as a polyvinylidene fluoride resin,) are preferred.

Examples of the polyvinylidene fluoride resin include a homopolymer of vinylidene fluoride (namely, polyvinylidene fluoride), a copolymer of vinylidene fluoride and another monomer copolymerizable with vinylidene fluoride (namely, a polyvinylidene fluoride copolymer), and any mixture of these resins. Examples of the monomer copolymerizable with vinylidene fluoride include tetrafluoroethylene, hexafluoropropylene, trifluoroethylene, trichloroethylene, and vinyl fluoride. One kind or two or more kinds of these monomers can be used. The polyvinylidene fluoride resin can be obtained by emulsion polymerization or suspension polymerization.

The resin to be contained in the porous layer is preferably a heat resistant resin (a resin having a melting temperature of 200° C. or higher, or a resin which does not have a melting temperature and has a decomposition temperature of 200° C. or higher), in terms of heat resistance. Examples of the heat resistant resin include polyamides (nylons), wholly aromatic polyamides (aramids), polyimides, polyamideimides, polysulfones, polyketones, polyether ketones, polyether sulfones, polyetherimides, celluloses, and any mixture of these resins. Among these, a wholly aromatic polyamide is preferred, in terms of ease of forming a porous structure, ability to bind to inorganic particles, and oxidation resistance. Among the wholly aromatic polyamides, a meta-type wholly aromatic polyamide is preferred, and polymetaphenylene isophthalamide is particularly preferred, in terms of ease of shaping.

[Inorganic Filler]

The porous layer preferably contains inorganic particles as the filler. The inorganic particle to be contained in the porous layer is preferably particles which are stable in an electrolyte solution, and at the same time, electrochemically stable. The porous layer may contain one kind of inorganic particles, or two or more kinds thereof.

Examples of the inorganic particles to be contained in the porous layer include: metal hydroxides such as aluminum hydroxide, magnesium hydroxide, calcium hydroxide, chromium hydroxide, zirconium hydroxide, cerium hydroxide, nickel hydroxide, and boron hydroxide; metal oxides such as silica, alumina, zirconia, and magnesium oxide; carbonates such as calcium carbonate and magnesium carbonate; sulfates such as barium sulfate and calcium sulfate; and clay minerals such as calcium silicate and talc. Among these, a metal hydroxide and a metal oxide are preferred, in terms of imparting flame retardancy or of a destaticizing effect. The inorganic particles may be particles which have been surface modified by a silane coupling agent or the like.

The inorganic particles may have an arbitrary shape, and may be in the shape of any of spheres, ellipsoids, plates, and needles, or may be amorphous. It is preferable that the primary particles of the inorganic particles have a volume average particle diameter of from 0.01 μm to 10 μm, and more preferably from 0.1 μm to 10 μm, in terms of shaping property of the porous layer, the substance permeability of the composite film, and the slippage of the composite film.

In a case in which the porous layer contains inorganic particles, a ratio of the inorganic particles with respect to a total amount of the resin and the inorganic particles is, for example, from 30% by volume to 90% by volume.

The porous layer may contain an organic filler or another component. Examples of the organic filler include: particles composed of crosslinked polymers such as crosslinked poly(meth)acrylic acids, crosslinked poly(meth) acid esters, crosslinked polysilicones, crosslinked polystyrenes, crosslinked polydivinylbenzenes, crosslinked products of styrene-divinylbenzene copolymers, polyimides, melamine resins, phenol resins, and benzoguanamine-formaldehyde condensation products; and particles composed of heat resistant resins such as polysulfones, polyacrylonitriles, aramids, polyacetals, and thermoplastic polyimides.

The porous layer preferably has a thickness, on one surface of the porous substrate, of from 0.5 μm to 5 μm, in terms of the mechanical strength.

The porous layer preferably has a porosity of from 30% to 80%, in terms of the mechanical strength, the handling property, and the substance permeability.

The porous layer preferably has a pore diameter of from 20 nm to 100 nm, in terms of the substance permeability. An average pore diameter of the porous layer herein refers to a value measured using a palm porometer, in accordance with ASTM E1294-89.

[Property of Composite Film]

A thickness of the composite film may be, for example, from 5 μm to 100 μm. When used as a battery separator, the composite film has a thickness of from 5 μm to 50 μm, for example.

The composite film preferably has a Gurley value (JIS P8117 (2009)) of from 50 sec/100 cc to 800 sec/100 cc, in terms of the mechanical strength and the substance permeability.

The composite film preferably has a porosity of from 30% to 60%, in terms of the mechanical strength, the handling property, and the substance permeability.

A porosity of the composite film is determined by the following equation. A porosity of the porous substrate and a porosity of the porous layer are also determined in the same manner.

Porosity (%)={1−(Wa/da+Wb/db+Wc/dc+ • • • +Wn/dn)/t}×100

In the equation, Wa, Wb, Wc, • • • , Wn are the weights (g/cm²) of constituent materials to a, b, c, • • • , n respectively: da, db, dc, • • • , dn are the true densities (g/cm³) of the constituent materials a, b, c, • • • , n respectively: and t is the film thickness (cm) of a layer of interest.

[Applications of Composite Film]

The composite film can be used, for example, as a battery separator, a film for a capacitor, a gas filter, a liquid filter, or the like. In particular, the composite film in the present disclosure is particularly suitably used as a nonaqueous secondary battery separator.

### EXAMPLES

Hereinafter, the present invention is described in further detail with reference to Examples. The material, amount of use, proportion, procedure, or the like described below can be appropriately modified without deviating from the spirit of the present invention. Therefore, the scope of the present invention should not be construed to be limited by the following specific examples.

<Method for Measurement of Physical Property>

The following measurement methods were applied in Examples and Comparative Examples.

[Film Thickness]

A film thickness (μm) of the porous substrate was obtained by measuring the thickness at arbitrary 20 points within an area of 10 cm×30 cm in the porous substrate, using a contact type thickness meter (LITEMATIC: manufactured by Mitutoyo Corporation), and by calculating an average of the measured values. The measurement was carried out using a measuring terminal having a cylinder form with a diameter of 5 mm, with a load applied during the measurement adjusted to 7 g.

[Tensile Strength at 2% Elongation and Elongation at Break in MD Direction]

Three samples each having a size of 10 cm in the MD direction×1 cm in the TD direction were cut out from the porous substrate. The samples were left to stand in an atmosphere at 20° C. for 24 hours or more, and then subjected to tensile test in the same atmosphere, using a tensile tester (TENSILON universal tester RTC-1210A, manufactured by Orientec Co., Ltd.) at a tensile speed of 100 mm/min. Averages of the measured values of the three samples were respectively obtained to be taken as the tensile strength at 2% elongation and the elongation at break of the porous substrate.

The tensile strength at 2% elongation in the MD direction was obtained by measuring the load at which each sample was elongated by 2%, and by calculating according to according to the following equation.

Tensile strength at 2% elongation (N/cm)=load (N) at 2% elongation/width (1 cm) of sample

The elongation at break in the MD direction was obtained by measuring the length at which each sample ruptured, and by calculating according to the following equation.

Elongation at break (%)=100×(L−Lo)/Lo

Lo: length (10 cm) of the sample before the test, L: length (cm) of the sample upon rupture.

[Rotational Resistance of Driven Roll]

A driven roll was disposed in the air such that the axial direction of the roll matches the horizontal direction. A thread was wound around the driven roll at the center in the width direction thereof, at a position where a groove is not provided. A load was gradually applied to one end of the thread hanging down in the direction of gravity, and the load (g) at which the roll at rest starts to rotate was measured. This measurement was carried out at an environment of a temperature of 20° C.

[Elongation of Composite Film]

Immediately before carrying out the water washing step, two marks were made at the center of the composite film in the TD direction, at an interval of 1 m in the MD direction. Immediately after the water washing step, the interval between the two marks was measured, and the rate of elongation (%) was calculated. Then the elongation of the composite film was classified based on the following standards.

A: The rate of elongation is less than 1%.

B: The rate of elongation is 1% or more but less than 2%.

C: The rate of elongation is 2% or more.

[Wrinkles of Composite Film]

Immediately after the water washing step and immediately after the drying step, an appearance of the composite film was visually observed, and the occurrence of wrinkles was classified based on the following standards.

A: No wrinkles were observed.

B: Slight wrinkles were observed immediately after the water washing step. The wrinkles disappear in the drying step.

C: Winkles were observed immediately after the water washing step. The wrinkles do not disappear in the drying step.

[Peeling of Porous Layer]

The composite film was tested by a defect tester, and the presence of a bright defect (a portion which is brighter than the surrounding portion) and a dark defect (a portion which is darker than the surrounding portion) was detected. The degree of peeling of the porous layer was classified according to the following standards, based on the size (maximum diameter) of the defects, and the number of the defects within an area of 100 m² in the composite film. A portion at which the porous layer is peeled is detected as the bright defect. A portion at which the peeled porous layer adhered to the surface of the composite film is detected as the dark defect.

A: The number of defects having a size of 500 μm or less is less than 10, and the number of defects having a size of 5 mm or less is less than one.

B: The number of defects having a size of 500 μm or less is 10 or more but less than 50, and the number of defects having a size of 5 mm or less is less than one.

C: The number of defects having a size of 500 μm or less is 50 or more, and the number of defects having a size of 5 mm or less is one or more.

<Preparation of Composite Film>

One water washing tank was prepared and disposed on a linear line connecting between a solidification step and a drying step.

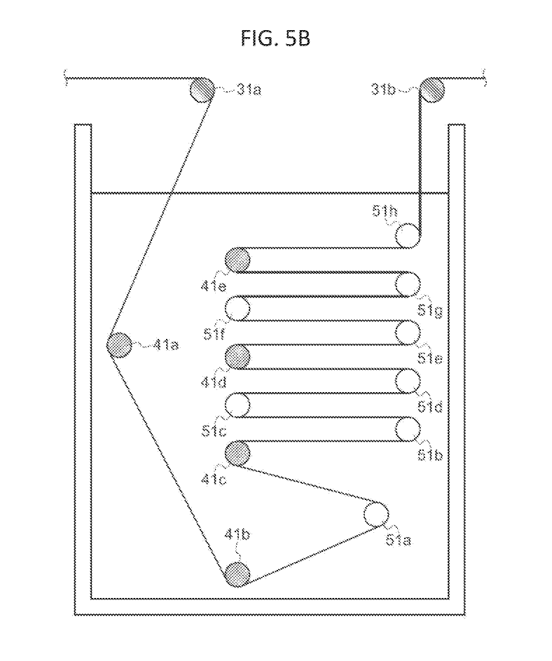

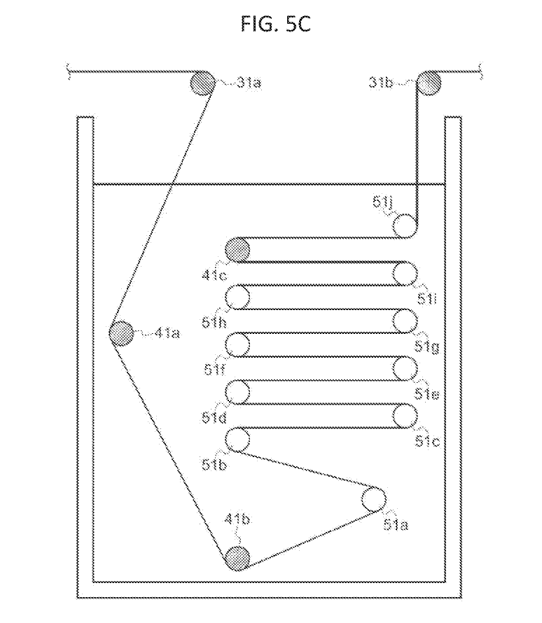

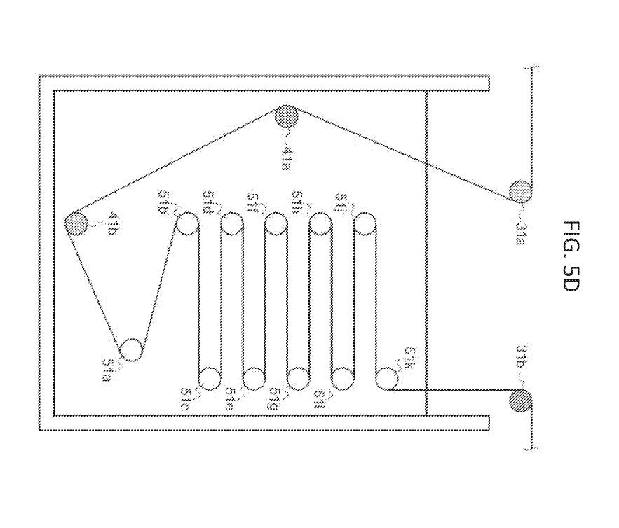

FIG. 5A is a schematic diagram showing a water washing tank used in Example 1. The water washing tank shown in FIG. 5A includes drive rolls 31a and 31b, drive rolls 41a to 41g, and driven rolls 51a to 51f These rolls are arranged such that the composite film is stepwisely transported upward from the bottom side to the water surface side of the water washing tank.

The drive rolls 31a and 31b are disposed at the upper side at the exterior of the water washing tank. The drive rolls 41a to 41g are disposed in the interior of the water washing tank. The drive rolls included in the water washing tank are arranged in the following order from the upstream side in the transport direction of the composite film: the drive rolls 31a. 41a, 41b, 41c, 41d, 41e, 41f, 41g, and 31b. The path length between any two adjacent drive rolls is 1.0 m.

The driven rolls 51a to 51f are disposed in the interior of the water washing tank. The driven rolls 51a and 51f are disposed at positions which divide the respective path lengths between two adjacent drive rolls into two equal distances.

In the water washing tank, water is filled to a level such that the drive rolls 41a to 41g and the driven roll 51a to 51f are immersed under water, and that the transport length under water of the composite film is 7.5 m.

The outer circumferential surface of each of the drive rolls is hard-chromium plated. On the outer circumferential surface of each of all the drive rolls, grooves each extending around the roll in the circumferential direction thereof are arranged spaced apart from each other at predetermined intervals in the width direction, as shown in FIG. 3A. The grooves have a width of 1 mm and a depth of 1 mm, are provided at intervals of 20 mm, and have the shape of a column.

The outer circumferential surface of each of the driven rolls is hard-chromium plated. On the outer circumferential surface of each of all the driven rolls, grooves each extending around the roll in the circumferential direction thereof are arranged spaced apart from each other at predetermined intervals in the width direction, as shown in FIG. 3A. The grooves have a width of 1 mm and a depth of 1 mm, are provided at intervals of 10 mm, and have the shape of a column. The rotational resistance per one driven roll is as shown in Table 1.

—Porous Substrate—

A polyethylene microporous film (PE film) having a long length and a width of 1 m was prepared as the porous substrate. Physical properties of the polyethylene microporous film are shown in Table 1.

—Coating Liquid Preparation Step—

Polymetaphenylene isophthalamide (PMIA) was dissolved in a solvent (a mixed solvent of dimethylacetamide and tripropylene glycol), and magnesium hydroxide was dispersed in the resultant, to obtain a coating liquid having a viscosity of 3,000 cP (centipoise). The coating liquid was prepared to have a composition (in mass ratio) of polymetaphenylene isophthalamide:magnesium hydroxide:dimethylacetamide:tripropylene glycol=4:16:48:32.

—Coating Step and Solidification Step—

The coating liquid (liquid temperature: 20° C.) obtained above was coated on both surfaces of the porous substrate in equal amounts, to form coating layers on both surfaces of the porous substrate. The porous substrate on which the coating layers had been formed was transported to a solidification tank, and immersed in a solidifying liquid (water: dimethylacetamide: tripropylene glycol=40:36:24 [mass ratio], liquid temperature: 30° C.) to solidify the resin contained in the coating layers, thereby obtaining a composite film.

—Water Washing Step and Drying Step—

The composite film was transported to the water washing tank controlled to a temperature of 30° C., at a transport speed of 70 m/min, and washed with water. After the composite film had been transported out of the water washing tank, the composite film was made to pass through a drying apparatus equipped with heating rolls to carry out drying.

The respective steps described above were carried out continuously, to obtain a composite film including a polyethylene microporous film and a porous layer formed on one surface of the polyethylene microporous film. The quality of the thus obtained composite film was evaluated, and the results are shown in Table 1. Data and the evaluation results of composite films obtained in other Examples and Comparative Examples are also shown in Table 1.

### Example 2

A composite film was prepared in the same manner as in Example 1, except that the washing tank is changed from one that is shown in FIG. 5A to one that is shown in FIG. 5B.

FIG. 5B is a schematic diagram showing a water washing tank used in Example 2. The water washing tank shown in FIG. 5B includes drive rolls 31a and 31b, drive rolls 41a to 41e, and driven rolls 51a to 51h. These rolls are arranged such that the composite film is stepwisely transported upward from the bottom side to the water surface side of the water washing tank.

The drive rolls 31a and 31b are disposed at the upper side at the exterior of the water washing tank. The drive rolls 41a to 41e are disposed in the interior of the water washing tank. The drive rolls included in the water washing tank are arranged in the following order from the upstream side in the transport direction of the composite film: the drive rolls 31a, 41a, 41b, 41c, 41d, 41e, and 31b. The path length between any two adjacent drive rolls of: the drive rolls 31a and 41a: the drive rolls 41a and 41b: the drive rolls 41b and 41c; and the drive rolls 41e and 31b, is 1.0 m. The path length between any two adjacent drive rolls of: the drive rolls 41c and 41d; and the drive rolls 41d and 41e, is 2.0 m.

The driven rolls 51a to 51h are disposed in the interior of the water washing tank. The driven rolls 51a and 51h are disposed at positions which divide the respective path lengths between two adjacent drive rolls into two equal distances. The driven rolls 51b to 51g are disposed at positions which divide the respective path lengths between two adjacent drive rolls into four equal distances.

In the water washing tank, water is filled to a level such that the drive rolls 41a to 41e and the driven roll 51a to 51h are immersed under water, and that the transport length under water of the composite film is 7.5 m.

The dimensions, shapes and the materials of the drive rolls and driven rolls are the same as those in Example 1. The rotational resistance per one driven roll is as shown in Table 1.

### Example 3

The same procedure as in Example 1 was done except that the water washing tank shown in FIG. 5C was used instead of the water washing tank shown in FIG. 5A, and that the transport speed of the composite film in the water washing step was changed to 50 m/min, to obtain a composite film.

FIG. 5C is a schematic diagram showing a water washing tank used in Example 3. The water washing tank shown in FIG. 5C includes drive rolls 31a and 31b, drive rolls 41a to 41c, and driven rolls 51a to 51j. These rolls are arranged such that the composite film is stepwisely transported upward from the bottom side to the water surface side of the water washing tank.

The drive rolls 31a and 31b are disposed at the upper side at the exterior of the water washing tank. The drive rolls 41a to 41c are disposed in the interior of the water washing tank. The drive rolls included in the water washing tank are arranged in the following order from the upstream side in the transport direction of the composite film: the drive rolls 31a, 41a, 41b, 41c, and 31b. The path length between any two adjacent drive rolls of: the drive rolls 31a and 41a; the drive rolls 41a and 41b; and the drive rolls 41c and 31b, is 1.0 m. The path length between any two adjacent drive rolls of the drive rolls 41b and 41c is 2.0 m.

The driven rolls 51a to 51j are disposed in the interior of the water washing tank. The driven rolls 51a and 51i are disposed at positions which divide the respective path lengths between two adjacent drive rolls into two equal distances. The driven roll 51j is disposed at a position which divides the path length between two adjacent drive rolls into two equal distances.

In the water washing tank, water is filled to a level such that the drive rolls 41a to 41c and the driven roll 51a to 51j are immersed under water, and that the transport length under water of the composite film is 7.5 m.

The dimensions, shapes and the materials of the drive rolls and driven rolls are the same as those in Example 1. The rotational resistance per one driven roll is as shown in Table 1.

### Comparative Example 1

The same procedure as in Example 1 was done except that the water washing tank shown in FIG. 5D was used instead of the water washing tank shown in FIG. 5A, and that the transport speed of the composite film in the water washing step was changed to 50 m/min, to obtain a composite film.

FIG. 5D is a schematic diagram showing a water washing tank used in Comparative Example 1. The water washing tank shown in FIG. 5C includes drive rolls 31a and 31b, drive rolls 41a and 41b, and driven rolls 51a to 51k. These rolls are arranged such that the composite film is stepwisely transported upward from the bottom side to the water surface side of the water washing tank.

The drive rolls 31a and 31b are disposed at the upper side at the exterior of the water washing tank. The drive rolls 41a and 41b are disposed in the interior of the water washing tank. The drive rolls included in the water washing tank are arranged in the following order from the upstream side in the transport direction of the composite film: the drive rolls 31a, 41a, 41b, and 31b. The path length between any two adjacent drive rolls of: the drive rolls 31a and 41a: and the drive rolls 41a and 41b, is 1.0 m. The path length between any two adjacent drive rolls of the drive rolls 41b and 31b is 6.0 m.

The driven rolls 51a to 51k are disposed in the interior of the water washing tank. The driven rolls 51a and 51k are disposed at positions which divide the respective path lengths between two adjacent drive rolls into twelve equal distances.

In the water washing tank, water is filled to a level such that the drive rolls 41a and 41b and the driven roll 51a to 51kj are immersed under water, and that the transport length under water of the composite film is 7.5 m.

The dimensions, shapes and the materials of the drive rolls and driven rolls are the same as those in Example 1. The rotational resistance per one driven roll is as shown in Table 1.

### Comparative Example 2

The same procedure as in Example 1 was done except that: all the rolls included in the water washing tank were replaced by drive rolls; a required number of the drive rolls were arranged such that the path lengths and the total transport length were as shown in Table 1; and the transport speed of the composite film in the water washing step was changed to 100 m/min: to obtain a composite film.

### Examples 4 to 8

Composite films were prepared in the same manner as in Example 2 respectively, except that the porous substrate and the conditions of the water washing were changed as shown in Table 1.

### Example 9

A composite film was prepared in the same manner as in Example 1, except that in the coating liquid preparation, polymetaphenylene isophthalamide was changed to polyvinylidene fluoride (PVDF).

### Example 10

A composite film was prepared in the same manner as in Example 1, except that the porous substrate was changed to a polyethylene terephthalate nonwoven fabric (PET nonwoven fabric).

TABLE 1

| | | | | | | | Rolls included in water washing tank | |
|---|---|---|---|---|---|---|---|---|
| | Porous substrate | | | | | | Path lengths | Rotational resistance |
| | | | Tensile | Elongation | Coating step | | between two | of driven roll(s) |
| | | | strength at 2% | at break | Resin | | adjacent drive | interposed (“Total” |
| | | Film | elongation in | in MD | contained in | | rolls (longest/ | denotes the |
| | | thickness | MD direction | direction | coating | Coated | shortest) | maximim value) |
| | Type | μm | N/cm | % | liquid | surface(s) | m | g/per roll |
| Example 1 | PE film | 10 | 2 | 80% | PMIA | Both | 1.0/1.0 | 5 |
| | | | | | | surfaces | | |
| Example 2 | PE film | 10 | 2 | 80% | PMIA | Both | 2.0/1.0 | 5 |
| | | | | | | surfaces | | |
| Example 3 | PE film | 10 | 2 | 80% | PMIA | Both | 5.0/1.0 | 5 |
| | | | | | | surfaces | | |
| Comparative | PE film | 10 | 2 | 80% | PMIA | Both | 6.0/1.0 | 5 |
| Example 1 | | | | | | surfaces | | |
| Comparative | PE film | 10 | 2 | 80% | PMIA | Both | 0.4/0.4 | 0 |
| Example 2 | | | | | | surfaces | | |
| Example 4 | PE film | 5 | 0.3 | 80% | PMIA | Both | 2.0/1.0 | 5 |
| | | | | | | surfaces | | |
| Example 5 | PE film | 10 | 1 | 80% | PMIA | Both | 2.0/1.0 | 5 |
| | | | | | | surfaces | | |
| Example 6 | PE film | 20 | 3 | 80% | PMIA | Both | 2.0/1.0 | 5 |
| | | | | | | surfaces | | |
| Example 7 | PE film | 10 | 2 | 80% | PMIA | Both | 2.0/1.0 | 5 |
| | | | | | | surfaces | | |
| Example 8 | PE film | 10 | 2 | 80% | PMIA | Both | 2.0/1.0 | 5 |
| | | | | | | surfaces | | |
| Example 9 | PE film | 10 | 2 | 80% | PVDF | Both | 1.0/1.0 | 5 |
| | | | | | | surfaces | | |
| Example 10 | PET | 20 | 3 | 15% | PMIA | Both | 1.0/1.0 | 5 |
| | nonwoven | | | | | surfaces | | |
| | fabric | | | | | | | |

| | Rolls included in water washing tank | | | | | | |
|---|---|---|---|---|---|---|---|
| | Rotational resistance | | | | | | |
| | of driven roll(s) | Water washing step | | | | | |
| | interposed (“Total” | Total transport | | | | | |
| | denotes the | length under | Transport | Water | | | |
| | maximim value) | water | speed | temperature | Composite film | | |
| | Total, g | m | m/min | ° C. | Elongation | Wrinkles | Peeling |
| Example 1 | 5 | 7.5 | 70 | 30 | A | A | A |
| Example 2 | 15 | 7.5 | 70 | 30 | B | B | A |
| Example 3 | 45 | 7.5 | 50 | 30 | B | B | B |
| Comparative | 55 | 7.5 | 50 | 30 | C | C | C |
| Example 1 | | | | | | | |
| Comparative | 0 | 7.5 | 100 | 30 | A | A | C |
| Example 2 | | | | | | | |
| Example 4 | 15 | 7.5 | 30 | 30 | B | B | B |
| Example 5 | 15 | 7.5 | 50 | 30 | B | B | B |
| Example 6 | 15 | 7.5 | 70 | 30 | B | A | A |
| Example 7 | 15 | 7.5 | 50 | 30 | A | A | A |
| Example 8 | 15 | 7.5 | 100 | 30 | B | B | B |
| Example 9 | 5 | 7.5 | 70 | 30 | A | A | A |
| Example 10 | 5 | 7 5 | 70 | 30 | A | A | A |

The disclosure of Japanese Patent Application No. 2015-067606, filed on Mar. 27, 2015, is incorporated herein by reference in its entirety.

All publications, patent applications, and technical standards mentioned in the present specification are incorporated herein by reference to the same extent as if such individual publication, patent application, or technical standard was specifically and individually indicated to be incorporated by reference.

1. A method of manufacturing a composite film, the method comprising:
a coating step comprising coating a coating liquid containing a resin on one surface or both surfaces of a porous substrate to form a coating layer, the porous substrate having a tensile strength at 2% elongation in a machine direction of 0.3 N/cm or more;
a solidification step comprising solidifying the resin by bringing the coating layer into contact with a solidifying liquid to obtain a composite film comprising the porous substrate and a porous layer that is formed on one surface or both surfaces of the porous substrate and that comprises the resin; and
a water wishing step comprising washing the composite film with water by transporting the composite film at a transport speed of 30 m/min or more in a water washing tank;
the water washing tank comprising two or more drive rolls for supporting and transporting the composite film, and a path length between any two adjacent drive rolls being from 0.5 m to 5 m.

2. The method of manufacturing a composite film according to claim 1, wherein at least one of the drive rolls includes a groove on an outer circumferential surface thereof.

3. The method of manufacturing a composite film according to claim 1, wherein in the water washing tank, at least one of spaces between the drive rolls is provided with at least one driven roll for supporting the composite film, and a total rotational resistance of the at least one driven roll disposed between two adjacent drive rolls is 50 g or less.

4. The method of manufacturing a composite film according to claim 1, wherein the porous substrate has a thickness of from 5 μm to 50 μm.

5. The method of manufacturing a composite film according to claim 1, wherein the porous substrate has an elongation at break in the machine direction of 10% or more.
